(19) United States
(12) Patent Application Publication
(10) Pub. No.: US 2013/0120342 A1
(43) Pub. Date: May 16, 2013

(54) LIGHT-EMITTING COMPONENT DRIVING CIRCUIT AND RELATED PIXEL CIRCUIT AND APPLICATIONS USING THE SAME

(71) Applicants: Wen-Chun Wang, Taichung City (TW); Hsi-Rong Han, Taichung City (TW); Wen-Tui Liao, Taichung City (TW); Chih-Hung Huang, Taichung City (TW); Tsung-Yu Wang, Taichung City (TW)

(72) Inventors: Wen-Chun Wang, Taichung City (TW); Hsi-Rong Han, Taichung City (TW); Wen-Tui Liao, Taichung City (TW); Chih-Hung Huang, Taichung City (TW); Tsung-Yu Wang, Taichung City (TW)

(21) Appl. No.: 13/672,715

(22) Filed: Nov. 9, 2012

(30) Foreign Application Priority Data
Nov. 11, 2011 (TW) 100141255

(51) Int. Cl. G09G 3/30

(52) U.S. Cl. CPC G09G 3/30
USPC 345/211; 345/76

(57) ABSTRACT

An organic light emitting diode (OLED) pixel circuit is provided by the invention. If a circuit configuration (5T2C) thereof collocates with suitable operation waveforms, a current flowing through an OLED in the OLED pixel circuit may not be changed with a power supply voltage (Vdd) influenced by an IR drop, and may not be varied with a threshold voltage (Vth) shift of a thin-film-transistor (TFT) configured for driving the OLED. Accordingly, brightness uniformity of an OLED display applying the same can be substantially improved.

### CROSS-REFERENCE TO RELATED APPLICATION

This application claims the priority benefit of Taiwan application serial no. 100141255, filed on Nov. 11, 2011. The entirety of the above-mentioned patent application is hereby incorporated by reference herein and made a part of this specification.

### BACKGROUND OF THE INVENTION

1. Field of the Invention

The present invention generally relates to a flat panel display technique, in particular, to a light-emitting component (for example, OLED) driving circuit and a related pixel circuit and applications using the same.

2. Description of Related Art

With rapid development of multi-media society, techniques of semi-conductor devices and display devices are also robustly developed. For the display, an active matrix organic light emitting diode (AMOLED) display has advantages of not having viewing angle limit, having a low manufacturing cost, having a high answering speed (approximately being hundreds of times of that of liquid crystal), being power saving, being self-luminous, being capable of being used for direct current driving of a portable machine, having a large working temperature scope, having a light weight, and being capable of being miniaturized and thinned along with the hardware device, so as to meet the characteristic demand of the display in the multi-media times. Therefore, the AMOLED display has a great development potential, and may become a new flat panel display of the next generation, thereby replacing a liquid crystal display (LCD).

Recently, mainly two manners for fabricating the AMOLED display panel exist, one is to utilize a low temperature poly-silicon (LTPS) thin-film-transistor (TFT) manufacturing technique, and the other is to utilize an amorphous silicon (a-Si) TFT manufacturing technique. The LTPS TFT manufacturing technique needs relatively many mask manufacturing processes, so as to result in rising of the cost. Therefore, recently, the LTPS TFT manufacturing technique is mainly applied to panels of small and medium sizes, and the a-Si TFT manufacturing technique is mainly applied to panels of great sizes.

Generally, for the AMOLED display panel fabricated by using the LTPS TFT manufacturing technique, TFT(s) in a pixel circuit may be P type or N type, but as the P type TFT conducting a positive voltage has a relatively excellent driving capability, recently the P type TFT is selected for implementation. However, when the P type TFT is selected for implementing the OLED pixel circuit, a current flowing through the OLED is not only changed with a power supply voltage (Vdd) influenced by an IR drop, but also varied with a threshold voltage (Vth) shift of a TFT used for driving the OLED. Accordingly, brightness uniformity of an OLED display is influenced.

### SUMMARY OF THE INVENTION

Accordingly, an exemplary embodiment of the present invention provides a pixel circuit, which includes a light-emitting component (for example, an OLED, but not limited thereto), first to fifth transistors, and first and second capacitors. The light-emitting component is configured for performing light emission in response to a driving current in an emission phase. The first transistor is configured for delivering a data voltage in response to a first scanning signal in a data-writing phase. The first capacitor is coupled between the first transistor and a reference voltage (for example, a ground potential, but not limited thereto), and configured for storing the data voltage in the data-writing phase. The second transistor is coupled to a power supply voltage, and configured for generating the driving current not influenced by the power supply voltage and a threshold voltage of the second transistor in the emission phase.

The third transistor is serially connected between the second transistor and the light-emitting component, and configured for delivering the driving current to the light-emitting component in response to an emission signal in the emission phase. The second capacitor is coupled between the first transistor and the second transistor, and configured for memorizing a charging voltage relevant to the threshold voltage of the second transistor in response to a second scanning signal in a voltage-memorizing phase, in which the charging voltage is changed in response to storage of the data voltage in the data-writing phase. The fourth transistor is coupled to the third transistor and the second capacitor, and configured for coordinating with the third transistor to initialize a first end voltage of the second capacitor in response to the second scanning signal in an initialization phase. The fifth transistor is coupled between the second capacitor and the reference voltage, and configured for initializing a second end voltage of the second capacitor in response to the second scanning signal in the initialization phase.

In an exemplary embodiment of the present invention, the pixel circuit successively enters the initialization phase, the voltage-memorizing phase, the data-writing phase, and the emission phase.

In an exemplary embodiment of the present invention, the first to the fifth transistors are P type transistors.

Another exemplary embodiment of the present invention provides an OLED display panel having the above provided pixel circuit.

In an exemplary embodiment of the present invention, the OLED display panel is fabricated by utilizing an LTPS TFT manufacturing technique.

Further another exemplary embodiment of the present invention provides an OLED display having the OLED display panel.

Still another exemplary embodiment of the present invention provides a light-emitting component driving circuit, configured under the above provided pixel circuit, not including the light-emitting component (i.e. OLED), but formed by first to fifth transistors and first and second capacitors.

Further still another exemplary embodiment of the present invention provides a light-emitting component driving circuit, which includes a driving unit, a data storage unit, and a voltage-memorizing unit. The driving unit is coupled between a power supply voltage and a light-emitting component (for example, an OLED), and includes a driving transistor, configured for controlling a driving current flowing through the light-emitting component in an emission phase. The data storage unit includes a first capacitor coupled to a reference voltage (for example, a ground potential), and is configured for receiving and delivering a data voltage to the first capacitor in a data-writing phase.

The voltage-memorizing unit is coupled between the driving unit and the data storage unit, and includes a second capacitor, configured for recording a threshold voltage of the driving transistor in a voltage-memorizing phase. In the emission phase, the driving unit generates the driving current flowing through the light-emitting component in response to the data voltage and the threshold voltage of the driving transistor, and the driving current is not influenced by the power supply voltage and the threshold voltage of the driving transistor.

In an exemplary embodiment of the present invention, a source of the driving transistor is coupled to the power supply voltage, and the driving unit further includes: an emission control transistor, having a gate configured for receiving an emission signal, a source coupled to a drain of the driving transistor, and a drain coupled to an anode of the OLED, in which a cathode of the OLED is coupled to the reference voltage.

In an exemplary embodiment of the present invention, the data storage unit further includes: a writing transistor, having a gate configured for receiving a first scanning signal, a source configured for receiving the data voltage, and a drain coupled to a first end of the first capacitor, in which a second end of the first capacitor is coupled to the reference voltage.

In an exemplary embodiment of the present invention, a first end of the second capacitor is coupled to the drain of the writing transistor and the first end of the first capacitor, a second end of the second capacitor is coupled to a gate of the driving transistor, and the voltage-memorizing unit further includes first and second transmission transistors. The first transmission transistor has a gate configured for receiving a second scanning signal, a source coupled to the drain of the driving transistor and the source of the emission control transistor, and a drain coupled to the gate of the driving transistor and the second end of the second capacitor. The second transmission transistor has a gate configured for receiving the second scanning signal, a source coupled to the drain of the writing transistor, the first end of the first capacitor and the first end of the second capacitor, and a drain coupled to the reference voltage.

In an exemplary embodiment of the present invention, the first transmission transistor is configured for coordinating with the emission control transistor to initialize a first end voltage of the second capacitor in response to the second scanning signal in an initialization phase; and the second transmission transistor is configured for initializing a second end voltage of the second capacitor in response to the second scanning signal in the initialization phase.

In an exemplary embodiment of the present invention, the driving transistor, the emission control transistor, the writing transistor, and the first and the second transmission transistors are P type transistors.

In an exemplary embodiment of the present invention, the light-emitting component driving circuit successively enters the initialization phase, the voltage-memorizing phase, the data-writing phase and the emission phase, and the data voltage is a negative voltage.

In an exemplary embodiment of the present invention, in the initialization phase, only the second scanning signal and the emission signal are enabled; in the voltage-memorizing phase, only the second scanning signal is enabled; in the data-writing phase, only the first scanning signal is enabled; and in the emission phase, only the emission signal is enabled.

In view of the above mentioned, the present invention provides an OLED pixel circuit. If a circuit configuration (5T2C) thereof collocates with suitable operation waveforms, a current flowing through an OLED in the OLED pixel circuit may not be changed with a power supply voltage Vdd influenced by an IR drop, and may not be varied with a threshold voltage Vth shift of a TFT configured for driving the OLED. Accordingly, brightness uniformity of an OLED display applying the same can be substantially improved.

It should be understood that the above general description and the detailed implementation manners are only exemplary and illustrative, and cannot limit the scope of the present invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an OLED pixel circuit 10 according to an exemplary embodiment of the present invention.

FIG. 2 is a circuit diagram of the OLED pixel circuit 10 of FIG. 1.

FIG. 3 is a diagram of operation waveforms of the OLED pixel circuit 10 of FIG. 1.

FIG. 4A is a schematic view of the OLED pixel circuit 10 of FIG. 1 in an initialization phase P1.

FIG. 4B is a schematic view of the OLED pixel circuit 10 of FIG. 1 in a voltage-memorizing phase P2.

FIG. 4C is a schematic view of the OLED pixel circuit 10 of FIG. 1 in a data-writing phase P3.

FIG. 4D is a schematic view of the OLED pixel circuit 10 of FIG. 1 in an emission phase P4.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

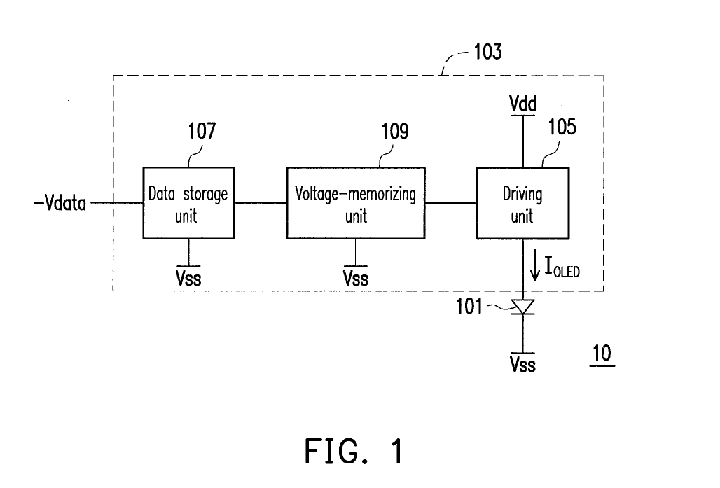

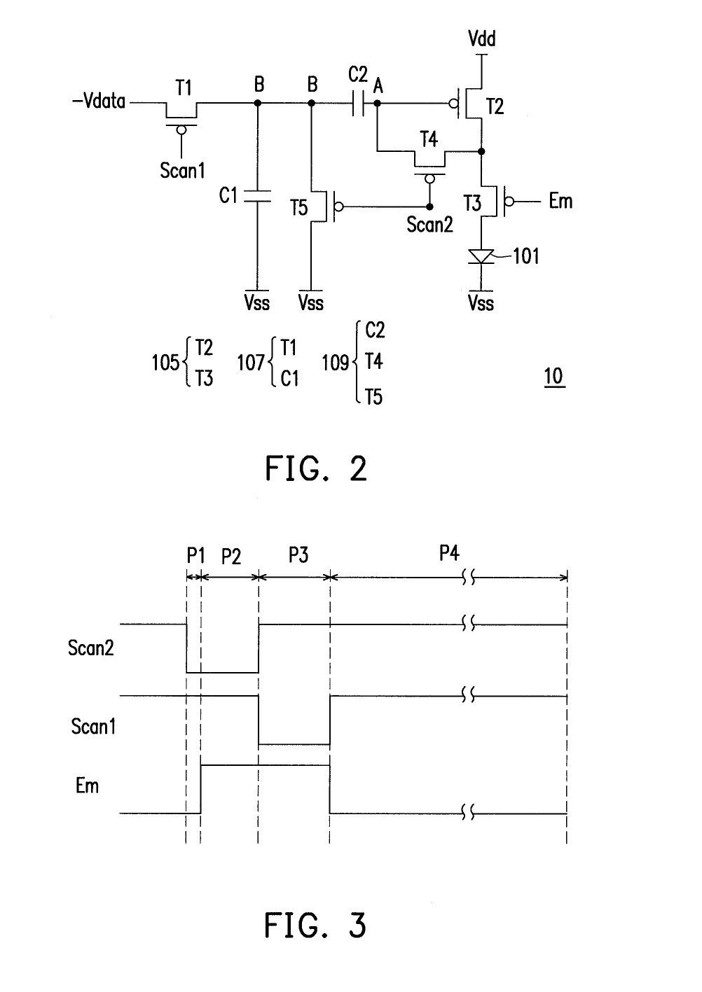

FIG. 1 is a schematic view of an OLED pixel circuit 10 according to an exemplary embodiment of the present invention, and FIG. 2 is a circuit diagram of the OLED pixel circuit 10 of FIG. 1. Referring to FIG. 1 and FIG. 2, the OLED pixel circuit 10 of this exemplary embodiment includes a light-emitting component (for example, an OLED 101, but not limited thereto) and a light-emitting component driving circuit 103. The light-emitting component driving circuit 103 includes a driving unit 105, a data storage unit 107, and a voltage-memorizing unit 109.

In this exemplary embodiment, the driving unit 105 is coupled between a power supply voltage and the OLED 101, and includes a driving transistor T2 (hereafter referred to as a second transistor T2). The driving unit 105 is configured for controlling a driving current I_{OLED} flowing through the OLED 101 in an emission phase.

The data storage unit 107 includes a first capacitor C1 coupled to a reference voltage Vss (for preferably example, a ground potential, but not limited thereto), and is configured for receiving and storing a data voltage −Vdata to the first capacitor C1 in a data-writing phase. The voltage-memorizing unit 109 is coupled between the driving unit 105 and the data storage unit 107, and includes a second capacitor C2. The voltage-memorizing unit 109 is configured for recording a threshold voltage Vₜₕ(T2) of the second transistor T2 in a voltage-memorizing phase.

In this exemplary embodiment, the driving unit 105 generates the driving current I_{OLED} flowing through the OLED 101 in response to the data voltage −Vdata and the threshold voltage (Vₜₕ(T2)) of the second transistor T2 in the emission phase, and the driving current I_{OLED} is not influenced by the power supply voltage Vdd and the threshold voltage (Vₜₕ(T2)) of the second transistor T2. In other words, the driving current I_{OLED} is irrelevant to the power supply voltage Vdd and the threshold voltage (Vₜₕ(T2)) of the second transistor T2.

In addition, the driving unit 105 further includes an emission control transistor T3 (hereafter referred to as a third transistor T3); the data storage unit 107 further includes a writing transistor T1 (hereafter referred to as a first transistor T1); and the voltage-memorizing unit 109 further includes a first transmission transistor and a second transmission transistor T4, T5 (hereafter referred to as a fourth transistor and a fifth transistor T4, T5 respectively).

In this exemplary embodiment, the first to the fifth transistors T1-T5 are P-type transistors, for example, P-type TFTs. Accordingly, an OLED display panel applying the OLED pixel circuit 10 may be fabricated by utilizing an LTPS TFT manufacturing technique.

In addition, on a circuit structure of the OLED pixel circuit 10, a gate of the first transistor T1 is configured for receiving a first scanning signal Scan1, and a source of the first transistor T1 is configured for receiving the data voltage −Vdata (being a negative voltage). A first end of the first capacitor C1 is coupled to a drain of the first transistor T1, and a second end of the first capacitor C1 is coupled to the reference voltage Vss.

A first end of the second capacitor C2 is coupled to the drain of the first transistor T1 and the first end of the first capacitor C1. A gate of the second transistor T2 is coupled to a second end of the second capacitor C2, and a source of the second transistor T2 is coupled to the power supply voltage Vdd. A gate of the third transistor T3 is configured for receiving an emission signal Em, and a source of the third transistor T3 is coupled to a drain of the second transistor T2. An anode of the OLED 101 (i.e. the first terminal of the light-emitting component) is coupled to a drain of the third transistor T3, and a cathode of the OLED 101 (i.e. the second terminal of the light-emitting component) is coupled to the reference voltage Vss (i.e. the ground potential).

A gate of the fourth transistor T4 is configured for receiving a second scanning signal Scan2, a source of the fourth transistor T4 is coupled to the drain of the second transistor T2 and the source of the third transistor T3, and a drain of the fourth transistor T4 is coupled to the gate of the second transistor T2 and the second end of the second capacitor C2. A gate of the fifth transistor T5 is configured for receiving the second scanning signal Scan2, a source of the fifth transistor T5 is coupled to the drain of the first transistor T1, the first end of the first capacitor C1 and the first end of the second capacitor C2, and a drain of the fifth transistor T5 is coupled to the reference voltage Vss.

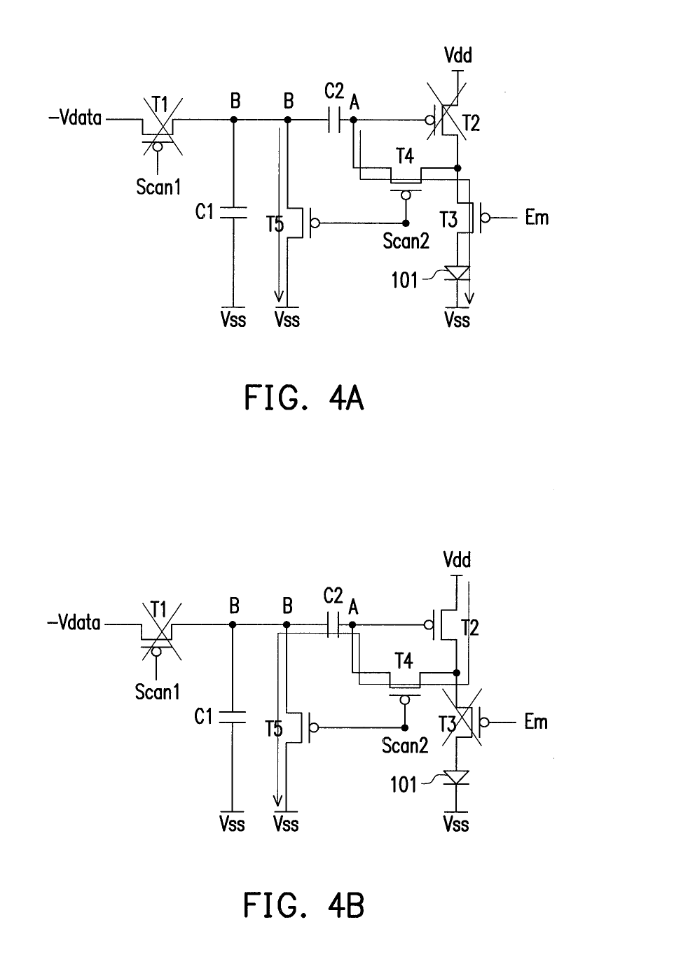

During an operation process, the OLED pixel circuit 10 successively enters an initialization phase, the voltage-memorizing phase, the data-writing phase, and the emission phase, for example, being P1-P4 as shown in FIG. 3 respectively. It may be clearly known from FIG. 3 that in the initialization phase P1, only the second scanning signal Scan2 and the emission signal Em are enabled. In the voltage-memorizing phase P2, only the second scanning signal Scan2 is enabled. In the data-writing phase P3, only the first scanning signal Scan1 is enabled. In emission phase P4, only the emission signal Em is enabled.

Here, it should be explained that as the type of the first to the fifth transistors T1-T5 in the OLED pixel circuit 10 is the P type, it may be known that the first to the fifth transistors T1-T5 are low active. Accordingly, the description, in which the first scanning signal Scan1, the second scanning signal Scan2, and the emission signal Em are enabled, represents that the first scanning signal Scan1, the second scanning signal Scan2, and the emission signal Em are in the low level.

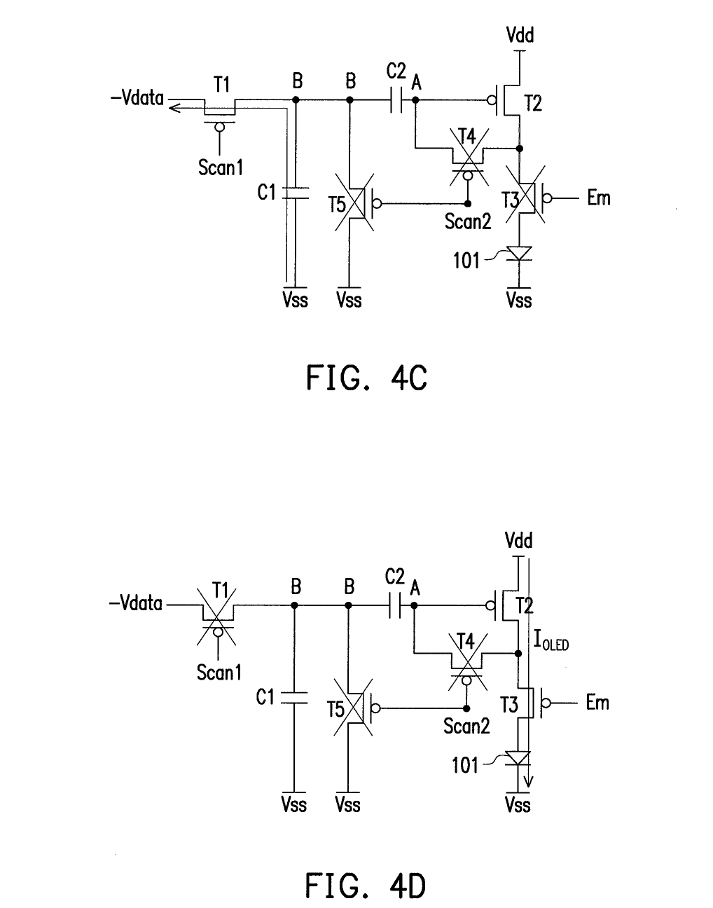

Firstly, when the OLED pixel circuit 10 is in the initialization phase P1, only the second scanning signal Scan2 and the emission signal Em are enabled, so that as shown in FIG. 4A, the first and the second transistors T1, T2 may be turned-off (with X), and the third to the fifth transistors T3-T5 are turned-on (without X). Accordingly, the fourth transistor T4 coordinates with the third transistor T3 to initialize a first end voltage of the second capacitor C2 in response to the second scanning signal Scan2 (that is, a voltage at a node A is substantially the reference voltage Vss (i.e. the first terminal of the light-emitting component)). In addition, the fifth transistor T5 initializes a second end voltage of the second capacitor C2 and a first end voltage of the first capacitor C1 in response to the second scanning signal Scan2 (that is, a voltage at a node B is substantially the reference voltage Vss (i.e. the ground potential)).

Next, when the OLED pixel circuit 10 is in the voltage-memorizing phase P2, only the second scanning signal Scan2 is enabled, so that as shown in FIG. 4B, the first and the third transistors T1, T3 are turned-off (with X), and the second, the fourth, and the fifth transistors T2, T3, T4 are turned-on (without X). Accordingly, the second capacitor C2 memorizes/stores a charging voltage (that is, Vdd−Vₜₕ(T2)) relevant to the threshold voltage (Vₜₕ(T2)) of the second transistor T2 in response to the second scanning signal Scan2. In other words, when the OLED pixel circuit 10 is in the voltage-memorizing phase P2, the power supply voltage Vdd charges the second capacitor C2, so that the second capacitor C2 memorizes/stores the charging voltage Vdd−Vₜₕ(T2).

Afterwards, when the OLED pixel circuit 10 is in the data-writing phase P3, only the first scanning signal Scan1 is enabled, so that as shown in FIG. 4C, the first and the second transistors T1, T2 are turned-on (without X), and the third to the fifth transistors T3-T5 are turned-off (with X). Accordingly, the first transistor T1 may deliver the data voltage −Vdata in response to the first scanning signal Scan1, such that the first capacitor C1 would store the data voltage −Vdata.

In the data-writing phase P3, based on a capacitive coupling effect, the charging voltage Vdd−Vₜₕ(T2) memorized/stored by the second capacitor C2 in the voltage-memorizing phase P2 may be changed in response to storage of the data voltage −Vdata. More clearly, as the data voltage −Vdata is stored in the data-writing phase P3 in response to the first capacitor C1, here the voltage at the node B may be considered as the data voltage −Vdata, and the voltage at the node A (that is, a gate voltage Vg of the second transistor T2) is influenced by the capacitive coupling effect of the second capacitor C2, and is changed from the original Vdd−Vₜₕ(T2) to −Vdata+Vdd−Vth(T2). This is the reason that in the data-writing phase P3, the charging voltage Vdd−Vₜₕ(T2) memorized/stored by the second capacitor C2 in the voltage-memorizing phase P2 is changed.

Finally, when the OLED pixel circuit 10 is in the emission phase P4, only the emission signal Em is enabled, so that as shown in FIG. 4D, the second and the third transistors T2, T3 are turned-on (without X), and the first, the fourth, and the fifth transistor T1, T4, T5 are turned-off (with X). Accordingly, the second transistor T2 generates the driving current I_{OLED} not influenced by the power supply voltage Vdd and the threshold voltage Vₜₕ(T2) of the second transistor T2.

More clearly, in the emission phase P4, the driving current I_{OLED} generated by the second transistor T2 may be represented by Equation 1 in the following:

I_{OLED}=½K×(Vsg−Vₜₕ(T2))² 1,

K is a current constant relevant to the second transistor T2.

In addition, a source voltage (Vs) and the gate voltage (Vg) of the second transistor T2 are known, that is:

Vs=Vdd; and

Vg=−Vdata+Vdd−Vₜₕ(T2).

Therefore, if the source voltage Vs and the gate voltage Vg of the second transistor T2 being known is substituted in Equation 1, Equation 2 in the following is obtained:

I_{OLED}=½K×[Vdd−(Vdd−Vₜₕ(T2)−Vdata)−Vₜₕ(T2)]² 2,

Equation 2 may be further simplified to obtain Equation 3:

I_{OLED}=½K×(Vdata)² 3.

It may be known that the second transistor T2 may generate the driving current I_{OLED} not influenced by the power supply voltage Vdd and the threshold voltage Vₜₕ(T2) of the second transistor T2 in the emission phase P4.

On the other hand, in the emission phase P4, the third transistor T3 serially connected between the second transistor T2 and the OLED 101 delivers the driving current I_{OLED} not influenced by the power supply voltage Vdd and the threshold voltage Vₜₕ(T2) of the second transistor T2 to the OLED 101 in response to the emission signal Em. In this manner, the OLED 101 performs light emission in response to the delivered driving current I_{OLED}.

Accordingly, it may be known that a circuit configuration of the OLED pixel circuit 10 according to the exemplary embodiment is 5T2C (that is, 5 TFTs+2 capacitors), and if the circuit configuration collocates with suitable operation waveforms (as shown in FIG. 3), the current I_{OLED} flowing through the OLED 101 may not be changed with the power supply voltage Vdd influenced by an IR drop, and may not be varied with a threshold voltage Vth shift of the TFT T2 configured for driving the OLED 101. Accordingly, brightness uniformity of the OLED display applying the same can be substantially improved. In addition, any OLED display panel applying the OLED pixel circuit 10 according to the exemplary embodiment and the OLED display thereof are within the protection scope of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents. In addition, any embodiment or claim of the present invention needs not to achieve all the objectives, advantages, or features of the present invention. Moreover, the abstract and the title are only used to facilitate searching of the patent documents, without limiting the scope of the present invention.

What is claimed is:

1. A pixel circuit, comprising:
a light-emitting component, configured for performing light emission in response to a driving current in an emission phase;
a first transistor, configured for delivering a data voltage in response to a first scanning signal in a data-writing phase;
a first capacitor, coupled between the first transistor and a reference voltage, and configured for storing the data voltage in the data-writing phase;
a second transistor, coupled to a power supply voltage, and configured for generating the driving current not influenced by the power supply voltage and a threshold voltage of the second transistor in the emission phase;
a third transistor, serially connected between the second transistor and the light-emitting component, and configured for delivering the driving current to the light-emitting component in response to an emission signal in the emission phase;
a second capacitor, coupled between the first transistor and the second transistor, and configured for memorizing a charging voltage relevant to the threshold voltage of the second transistor in response to a second scanning signal in a voltage-memorizing phase, wherein the charging voltage is changed in response to storage of the data voltage in the data-writing phase;
a fourth transistor, coupled to the third transistor and the second capacitor, and configured for coordinating with the third transistor to initialize a first end voltage of the second capacitor in response to the second scanning signal in an initialization phase; and
a fifth transistor, coupled between the second capacitor and the reference voltage, and configured for initializing a second end voltage of the second capacitor in response to the second scanning signal in the initialization phase.

2. The pixel circuit according to claim 1, wherein the pixel circuit successively enters the initialization phase, the voltage-memorizing phase, the data-writing phase, and the emission phase.

3. The pixel circuit according to claim 2, wherein the data voltage is a negative voltage.

4. The pixel circuit according to claim 3, wherein:
a gate of the first transistor is configured for receiving the first scanning signal, and a source of the first transistor is configured for receiving the data voltage;
a first end of the first capacitor is coupled to a drain of the first transistor, and a second end of the first capacitor is coupled to the reference voltage;
a first end of the second capacitor is coupled to the drain of the first transistor and the first end of the first capacitor;
a gate of the second transistor is coupled to a second end of the second capacitor, and a source of the second transistor is coupled to the power supply voltage;
a gate of the third transistor is configured for receiving the emission signal, and a source of the third transistor is coupled to a drain of the second transistor;
a first terminal of the light-emitting component is coupled to a drain of the third transistor, and a second terminal of the light-emitting component is coupled to the reference voltage;
a gate of the fourth transistor is configured for receiving the second scanning signal, a source of the fourth transistor is coupled to the drain of the second transistor and the source of the third transistor, and a drain of the fourth transistor is coupled to the gate of the second transistor and the second end of the second capacitor; and
a gate of the fifth transistor is configured for receiving the second scanning signal, a source of the fifth transistor is coupled to the drain of the first transistor, the first end of the first capacitor and the first end of the second capacitor, and a drain of the fifth transistor is coupled to the reference voltage,
wherein the light-emitting component is an organic light emitting diode (OLED), the first terminal of the light-emitting component is an anode of the OLED, and the second terminal of the light-emitting component is a cathode of the OLED,
wherein the reference voltage is a ground potential.

5. The pixel circuit according to claim 4, wherein the first to the fifth transistors are P type transistors.

6. The pixel circuit according to claim 5, wherein:
in the initialization phase, only the second scanning signal and the emission signal are enabled;
in the voltage-memorizing phase, only the second scanning signal is enabled;
in the data-writing phase, only the first scanning signal is enabled; and
in the emission phase, only the emission signal is enabled.

7. A display panel comprising the pixel circuit as claimed in claim 1.

8. The display panel according to claim 7, wherein the display panel is an OLED display panel, and the OLED display panel is fabricated by utilizing a low temperature poly-silicon (LTPS) thin-film-transistor (TFT) manufacturing technique.

9. A display comprising the OLED display panel as claimed in claim 8.

10. A light-emitting component driving circuit, comprising:
a first transistor, configured for delivering a data voltage in response to a first scanning signal in a data-writing phase;
a first capacitor, coupled between the first transistor and a reference voltage, and configured for storing the data voltage in the data-writing phase;
a second transistor, coupled to a power supply voltage, and configured for generating a driving current not influenced by the power supply voltage and a threshold voltage of the second transistor in an emission phase;
a third transistor, serially connected between the second transistor and a light-emitting component, and configured for delivering the driving current to the light-emitting component in response to an emission signal in the emission phase, so as to drive the light-emitting component to perform light emission;
a second capacitor, coupled between the first transistor and the second transistor, and configured for memorizing a charging voltage relevant to the threshold voltage of the second transistor in response to a second scanning signal in a voltage-memorizing phase, wherein the charging voltage is changed in response to storage of the data voltage in the data-writing phase;
a fourth transistor, coupled to the third transistor and the second capacitor, and configured for coordinating with the third transistor to initialize a first end voltage of the second capacitor in response to the second scanning signal in an initialization phase; and
a fifth transistor, coupled between the second capacitor and the reference voltage, and configured for initializing a second end voltage of the second capacitor in response to the second scanning signal in the initialization phase.

11. The light-emitting component driving circuit according to claim 10, wherein the light-emitting component driving circuit successively enters the initialization phase, the voltage-memorizing phase, the data-writing phase, and the emission phase.

12. The light-emitting component driving circuit according to claim 11, wherein the data voltage is a negative voltage.

13. The light-emitting component driving circuit according to claim 12, wherein:
a gate of the first transistor is configured for receiving the first scanning signal, and a source of the first transistor is configured for receiving the data voltage;
a first end of the first capacitor is coupled to a drain of the first transistor, and a second end of the first capacitor is coupled to the reference voltage;
a first end of the second capacitor is coupled to the drain of the first transistor and the first end of the first capacitor;
a gate of the second transistor is coupled to a second end of the second capacitor, and a source of the second transistor is coupled to the power supply voltage;
a gate of the third transistor is configured for receiving the emission signal, and a source of the third transistor is coupled to a drain of the second transistor;
a first terminal of the light-emitting component is coupled to a drain of the third transistor, and a second terminal of the light-emitting component is coupled to the reference voltage;
a gate of the fourth transistor is configured for receiving the second scanning signal, a source of the fourth transistor is coupled to the drain of the second transistor and the source of the third transistor, and a drain of the fourth transistor is coupled to the gate of the second transistor and the second end of the second capacitor; and
a gate of the fifth transistor is configured for receiving the second scanning signal, a source of the fifth transistor is coupled to the drain of the first transistor, the first end of the first capacitor and the first end of the second capacitor, and a drain of the fifth transistor is coupled to the reference voltage,
wherein the light-emitting component is an organic light emitting diode (OLED), the first terminal of the light-emitting component is an anode of the OLED, and the second terminal of the light-emitting component is a cathode of the OLED,
wherein the reference voltage is a ground potential.

14. The light-emitting component driving circuit according to claim 13, wherein the first to the fifth transistors are P type transistors.

15. The light-emitting component driving circuit according to claim 14, wherein:
in the initialization phase, only the second scanning signal and the emission signal are enabled;
in the voltage-memorizing phase, only the second scanning signal is enabled;
in the data-writing phase, only the first scanning signal is enabled; and
in the emission phase, only the emission signal is enabled.

16. A light-emitting component driving circuit, comprising:
a driving unit, coupled between a power supply voltage and a light-emitting component, and comprising a driving transistor, configured for controlling a driving current flowing through the light-emitting component in an emission phase;
a data storage unit, comprising a first capacitor coupled to a reference voltage, and configured for receiving and storing a data voltage to the first capacitor in a data-writing phase; and
a voltage-memorizing unit, coupled between the driving unit and the data storage unit, and comprising a second capacitor, configured for recording a threshold voltage of the driving transistor in a voltage-memorizing phase,
wherein in the emission phase, the driving unit generates the driving current flowing through the light-emitting component in response to the data voltage and the threshold voltage of the driving transistor, and the driving current is not influenced by the power supply voltage and the threshold voltage of the driving transistor.

17. The light-emitting component driving circuit according to claim 16, wherein a source of the driving transistor is coupled to the power supply voltage, and the driving unit further comprises:
an emission control transistor, having a gate configured for receiving an emission signal, a source coupled to a drain of the driving transistor, and a drain coupled to a first terminal of the light-emitting component, wherein a second terminal of the light-emitting component is coupled to the reference voltage,
wherein the light-emitting component is an organic light emitting diode (OLED), the first terminal of the light-emitting component is an anode of the OLED, and the second terminal of the light-emitting component is a cathode of the OLED,
wherein the reference voltage is a ground potential.

18. The light-emitting component driving circuit according to claim 17, wherein the data storage unit further comprises:
a writing transistor, having a gate configured for receiving a first scanning signal, a source configured for receiving the data voltage, and a drain coupled to a first end of the first capacitor, wherein a second end of the first capacitor is coupled to the reference voltage.

19. The light-emitting component driving circuit according to claim 18, wherein a first end of the second capacitor is coupled to the drain of the writing transistor and the first end of the first capacitor, a second end of the second capacitor is coupled to a gate of the driving transistor, and the voltage-memorizing unit further comprises:
a first transmission transistor, having a gate configured for receiving a second scanning signal, a source coupled to the drain of the driving transistor and the source of the emission control transistor, and a drain coupled to the gate of the driving transistor and the second end of the second capacitor; and
a second transmission transistor, having a gate configured for receiving the second scanning signal, a source coupled to the drain of the writing transistor, the first end of the first capacitor and the first end of the second capacitor, and a drain coupled to the reference voltage.

20. The light-emitting component driving circuit according to claim 19, wherein:
the first transmission transistor is configured for coordinating with the emission control transistor to initialize a first end voltage of the second capacitor in response to the second scanning signal in an initialization phase; and
the second transmission transistor is configured for initializing a second end voltage of the second capacitor in response to the second scanning signal in the initialization phase.

21. The light-emitting component driving circuit according to claim 20, wherein the light-emitting component driving circuit successively enters the initialization phase, the voltage-memorizing phase, the data-writing phase, and the emission phase.

22. The light-emitting component driving circuit according to claim 20, wherein the data voltage is a negative voltage.

23. The light-emitting component driving circuit according to claim 22, wherein the driving transistor, the emission control transistor, the writing transistor, and the first and the second transmission transistors are P type transistors.

24. The light-emitting component driving circuit according to claim 23, wherein:
in the initialization phase, only the second scanning signal and the emission signal are enabled;
in the voltage-memorizing phase, only the second scanning signal is enabled;
in the data-writing phase, only the first scanning signal is enabled; and
in the emission phase, only the emission signal is enabled.
